(19) United States
(12) Patent Application Publication
(10) Pub. No.: US 2007/0211056 A1
(43) Pub. Date: Sep. 13, 2007

(54) Multi-dimensional data visualization

(76) Inventors: Sudip Chakraborty, Arlington, MA (US); Mark Pinis, Newton, MA (US); Priyanka Naithani, Stow, MA (US); John Morey, Newtonville, MA (US); Charles Douglis, Belmont, MA (US); Larry Floryan, Jefferson, MA (US)

Correspondence Address: FISH & RICHARDSON PC, P.O. BOX 1022, MINNEAPOLIS, MN, 55440-1022, US

(21) Appl. No.: 11/370,606

(22) Filed: Mar. 8, 2006

(51) Int. Cl. G06T 11/20

(52) U.S. Cl. 345/440

(57) ABSTRACT

Techniques for generating a visual data model include providing first and second objects that represent first and second portions of data from a model; assigning attributes to the first and second objects, the attributes representing characteristics of the first and second portions of the data; providing a relationship object that represents a relationship between the first and second objects; and assigning, to the relationship object, a relationship attribute representing a characteristic of the relationship between the first and second objects.

### TECHNICAL FIELD

This invention relates to the visualization and analysis of data, and more particularly to generating multi-dimensional visual models of data relationships.

### BACKGROUND

Visual representations of data models, referred to as visual data models, display data in a visual format such as a chart or a graph. Visual data models may be used by a company or organization for modeling strategic plans and gaining insight into the opportunities, costs, and risks associated with pursuing various strategies. A visual data model may allow a user to display, manipulate, and analyze data pertaining to one or more aspects of the company or organization, which may include, for example, operations, historical activities, management, and overall performance. The data provided to a visual data model may be collected from a variety of tools that may, for example, support, measure, and automate various business processes; gather, analyze, and report on financial results, market data, and customer buying trends; and measure progress and costs of project initiatives.

Visual data modeling systems are used to create visual data models and often are computer-based programs. Visual data modeling systems may, for example, produce charts and email for communication; spreadsheets, databases, and graphs for analysis; and system dashboards and project plans for monitoring progress and results. Visual data modeling systems may employ data storage technologies ranging from simple flat file and sequential database indexing methods to more sophisticated relational and object oriented database systems.

Data modeling systems may include various database report generation tools. An example of a database report generation tool is an interactive spreadsheet that displays two-dimensional table projections of multi-dimensional data from on-line analytical processing (OLAP) cubes and pivot tables. Another example of a report generation tool is a graphing package. A graphing package may support the mapping of many data dimensions through the use of x-y-z coordinates as well as color, size and shape of displayed objects. A graphing package may also support CAD/CAM like features (e.g. interactive rotation, pan, zoom, coordinate remapping, filtering, etc.)

As the volume of data grows and data relationships become more complex, presenting data in a manner that can be quickly and easily analyzed often becomes more difficult.

### SUMMARY

The invention includes methods and systems, including computer programs, for modeling data.

In an aspect, a computer-implemented method for generating a visual data model includes providing first and second objects that represent first and second portions of data from a model; assigning attributes to the first and second objects, the attributes representing characteristics of the first and second portions of the data; providing a relationship object that represents a relationship between the first and second objects; and assigning, to the relationship object, a relationship attribute representing a characteristic of the relationship between the first and second objects.

In another aspect, a system for generating a visual representation of a model includes a model builder configured to produce objects of entities, roles, and relationships from data associated with the model; and a view builder configured to create visual representations for the objects and to arrange the visual representations in a three-dimensional view.

Implementations may include one or more of the following features. A visual property of a first visual object representing the first object (e.g., an object associated with an entity) may be mapped to a characteristic of the data. Similarly, a visual property of a second visual object representing the second object (e.g., an object associated with a role) may be mapped to another characteristic of the data. A visual property of a connector object representing the relationship object may be mapped to a characteristic of the data. Examples of visual properties include: a shape, a color, a dimension, a transparency level, and a label. The first and second visual objects and the connector object may be displayed in a three-dimensional view space rendered on a two-dimensional surface. The first and second visual objects may be connected to the connector object. The first and second visual objects may be anchored to respective first and second parallel planes within the three-dimensional view space and rotated about an axis such that the visual objects rotate with the parallel planes. The display of a subset of the visual objects may be suppressed, for example, by applying one or more of: a select filter, a pathlight filter, and a spot light filter. A rolled-up attribute that depends at least in part on an attribute (e.g., a relationship attribute) may be defined. The attributes, including the relationship attribute, may be time stamped.

The data may be imported from a source that includes at least one of: an online transaction processing (OLTP) database, an online analytical processing (OLAP) database, a spreadsheet, an extensible markup language (XML) file, a hypertext-markup language (HTML) page, a text file, and a screen input. The data from the source may be received over a communications network.

A data import module for importing the data from a source and a data output module for storing the data in an output file may be provided. Examples of an output file include: a chart, a graph, an extensible markup language (XML) file, and a database. A network configured to transmit data to the data import module from a server connected to the network and to transmit data from the data output module to a server connected to the network may be provided.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a system for generating a visual data model.

FIG. 2 is a block diagram of the architecture of the system shown in FIG. 1.

FIG. 3a is a block diagram of relationships between exemplary object types.

FIG. 3b shows an exemplary database representation of an entity.

FIGS. 3c-3d show exemplary database representations of a relationship.

FIG. 3e shows an exemplary database representation of a role.

FIG. 3f shows an exemplary database representation of a parent/child relationship.

FIG. 3g shows an exemplary database representation of a parent/child relationship.

FIGS. 4-9 show examples of relationships between object types in context to a business environment model.

FIGS. 10-11 are exemplary model views of visual data models.

FIG. 12 shows an exemplary graphical user interface (GUI) for defining objects and relationships between the objects.

FIG. 13 is an exemplary GUI for defining and displaying attribute values.

FIG. 14 is an exemplary GUI for producing visual effects on a model view.

FIG. 15 shows an exemplary visual effect produced by a select operation.

FIG. 16 shows an exemplary visual effect produced by a spotlight operation.

FIG. 17 shows an exemplary visual effect produced by a pathlight operation.

FIG. 18 shows an exemplary visual effect produced by a select operation followed by a pathlight operation.

FIG. 19 shows a mapping operation in which the relative sizes of objects are mapped to an attribute value range.

FIG. 20 shows a visual effect produced by a combination of select, spotlight, pathlight, and mapping operations.

FIG. 21 shows an exemplary layout of objects in a visual data model.

FIG. 22 shows an exemplary GUI for viewing the values of visual properties of an object.

FIG. 23 shows a graphical charting window for comparing attributes of selected objects.

FIG. 24 shows a visual layout control for adjusting the spacing of objects.

FIG. 25 shows a fade control for adjusting a level of transparency of a window pane overlaying the visual data model.

FIG. 26 is a flowchart of a process for building an object model using the model builder in FIG. 2.

FIG. 27 is a flowchart of a process for producing a model view of the object model produced by the process in FIG. 26 using the view builder in FIG. 2.

### DETAILED DESCRIPTION

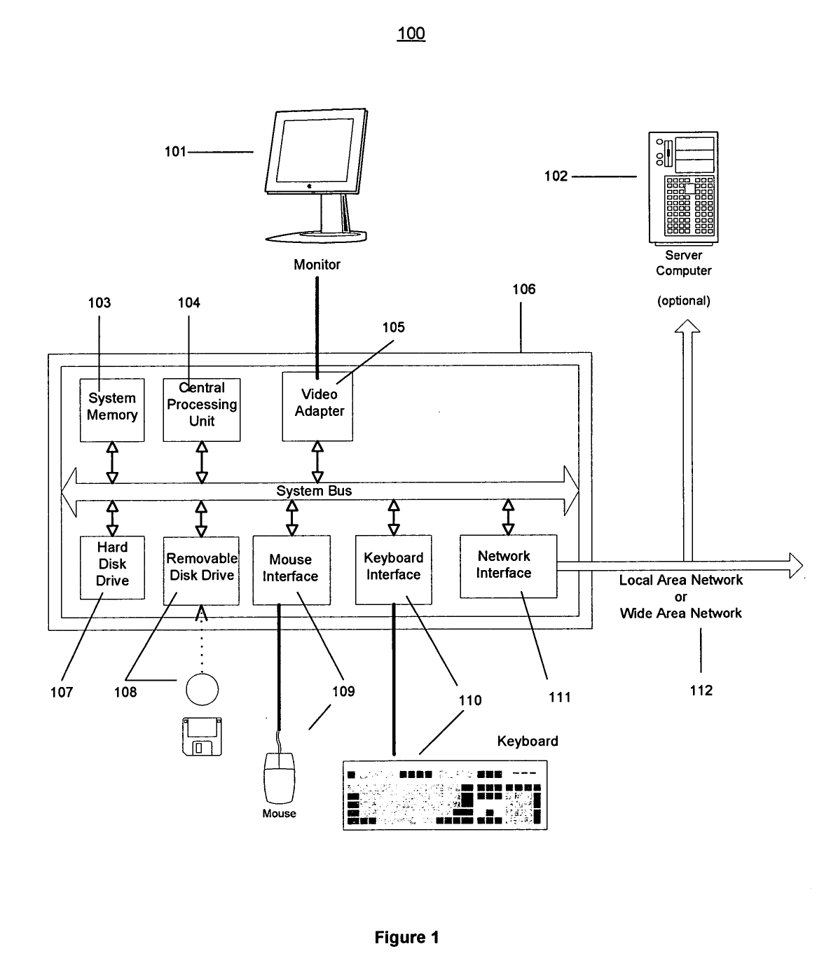

FIG.1 shows an exemplary system 100 for generating a visual data model. Visual data models may include business models, military models, scientific models, and other models that describe relationships between data in a system. The system 100 includes a personal computer 106 for executing computer code that generates a visual data model; a monitor 101 for displaying the model to a user; one or more input devices, such as keyboard 110 and mouse 109, removable media 108 such as a floppy disk, CD-ROM, or other storage mechanism from which software is loaded into the personal computer 106; one or more server computers 102 for storing data, and a communications network 112 for sending data from the server computer 102 to the personal computer 106. Personal computer 106 includes a hard disk drive 107 for storing data, system memory 103 for storing software, and a central processing unit 104 for executing the software stored in the system memory 103. The personal computer 106 also includes a video adapter 105 that interfaces the monitor 101, peripheral device interfaces 110, such as a mouse and keyboard interface, and a network interface 111.

In an exemplary embodiment, the software supports a single user environment. For this embodiment, the communications network 112, the network interface 1 11, and the server computers 112 may be absent from system 100. In other exemplary embodiments, the software supports multiple users collaborating on the development and use of one or more models. In these embodiments, visual data models and their data may be transmitted between multiple server computers 102 and personal computers 106 over a communications network 112. Examples of a communications network 112 include a local area network (LAN), a larger group of interconnected systems such as the Internet, a private intranet, and other similar wired or wireless networks.

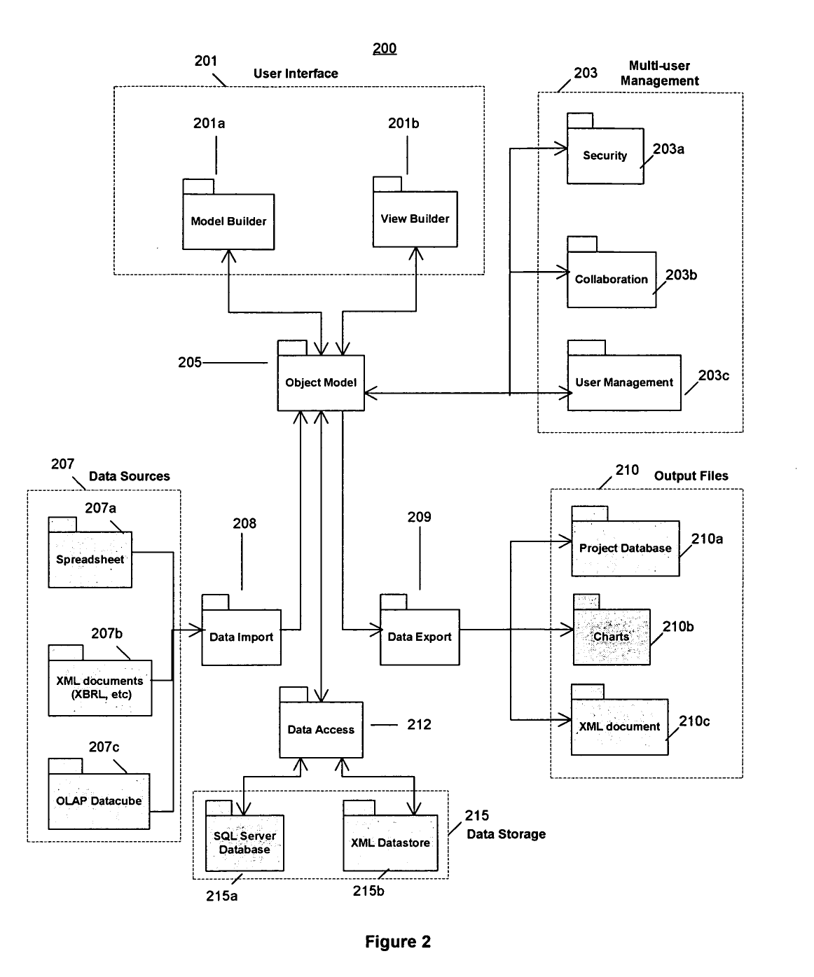

FIG. 2 shows an exemplary architecture 200 of the system 100. The architecture 200 includes an object model 205; a model builder 201a and view builder 201b (collectively referred to as interface components 201); multi-user management components 203; a data access component 212 for storing and accessing an object model 205 to and from data storage components 215, a data import component 208 for entering data from data sources 207 into the object model 205; and a data export component 209 for exporting data from an object model 205 to output files 210.

An object model 205 is a database representation of a data model. An object model 205 includes one or more data objects that describe a portion of data from a model. A data object includes a series of data fields, referred to as “attributes,” that correspond to various characteristics of the data described by the data objects. Data objects may be generated using an object-oriented computing language, such as JAVA or C++. A data object may be classified as an “entity” or a “role.” An entity describes an item or a process of a data model. In a model describing operations of an enterprise, for example, entities may describe business units within the enterprise, other companies that deal with the enterprise, products, employees, or the enterprise itself. A role describes an entity in relation to a particular role that the entity object may assume. For example, an entity may assume multiple roles that include buyer, seller, channel, and systems integrator.

Relationships between data objects may be represented by relationship objects. A relationship object includes “relationship attributes” that correspond to various characteristics of a relationship between two data objects. Examples of relationships include buyer/seller relationships, company/sub-division relationships, and market/market segment relationships.

The values assigned to attributes of relationship and data objects may be of a particular data type. Examples of data types include an alphanumeric string, an integer, a dollar amount, and a floating point decimal number.

The attributes of relationship objects and data objects may also be associated with a time value. A time value may include a single time or duration of time on a timeline. A time value may, for example, correspond to the time at which an attribute is updated or generated. A time value may also correspond a duration which the attribute is valid. For example, a revenue attribute may be associated with-a particular quarter of a particular year. Time values may be generated automatically or they may be user-specified.

The user interface components 201 include a model builder 201a and a view builder 201b. The model builder 201a is used for creating objects in the object model 205, for relating data to attributes of the objects, for associating relationships between the objects, for declaring the roles that objects of an entity may perform, and for associating time periods with the objects.

The view builder 201b is used to create three-dimensional visual representations for objects and their associated attributes within a three-dimensional space. The three-dimensional space may be rendered on a planar display, such as a LCD monitor, or shown using a volumetric display that forms an image in a three-dimensional volume. Examples of volumetric displays include swept-plane displays, emissive volume displays, varifocal mirror displays, laser displays, and holographic displays. An icon of a unique shape and color could be chosen to represent objects of a particular entity or role. In another example, a relationship between two objects could be represented using a distinctive connector icon. Furthermore, visual characteristics, such as height, width, and color, of icons representing objects and relationships could be configured to correlate with attribute values assigned to those objects. The view builder 201b may also be used to organize groups of related objects in planes within a three-dimensional space; to create visual effects, such as highlight objects meeting input criteria; and to perform CAD operations, including rotating, zooming, and panning, to manipulate a visual representation. Examples of these and other functions of the view builder 201b are later described.

The multi-user management components 203 include a security component 203a, a collaboration component 203b, and a user management component 203c. The security component 203 controls a user's access to objects, attribute values, and other components of the object model 205. The security component 203a may verify a user's identity using various authentication methods including login/password-based authentication, digital certificates, and digital signatures. The collaboration component 203b facilitates communication and coordination between multiple users. For example, the collaboration component may store and manage users' comments, annotations, and contributions to software describing the object model 205. The collaboration component 203b may, for example, include a database or a data log. The collaboration component 203b may also support tasks such as identification of milestones, assignment and notification of user responsibilities, and scheduling of meetings. The user management component 203c supports the specification of user access privileges. The user management component 203c may, for example, include an access database that contains a list of users, access privileges assigned to each of the users, and authentication information used to verify the users' identities. To specify access privileges for a new user, for example, a system administrator may add a new entry to the access database for the new user. A user may access any previously defined object model or may create a new model.

The data access component 212 moves the object models 205 between a permanent storage device, such as a hard drive, and the system memory 103. Data storage components 215, including one or more structured query language (SQL) relational databases 215a and extended markup language (XML) data files 215b, may be used to manage the permanent storage of an object model 205.

Data from a model may be imported from a variety of data sources 207 including spreadsheets 207a, XML documents 207b, and online analytical processing (OLAP) databases 207c. The data may be imported manually or automatically. Access to the data sources 207 and conversion of data formats is managed by the data import component 208. Data may also be exported from the object model 205 to one or more output files 210. Examples of output files include project databases 210a, charts 210b, and XML documents 210c. The data export component 209 converts the data to the output files 210.

Various types of data and relationship objects may be loaded into the data import component 208. Entities, roles, and relationships, referred to as “object types” may include predefined attributes. When an object of a particular object type is defined, the object inherits any predefined attributes assigned to its object type. In addition to predefined attributes, a data object type may include-one or more predefined relationships with other object types. A user may define new object types or modify a portion of an existing object type to create a new object type. An object model 205 may include objects derived from pre-defined object types, from user-defined object types, or from a combination thereof.

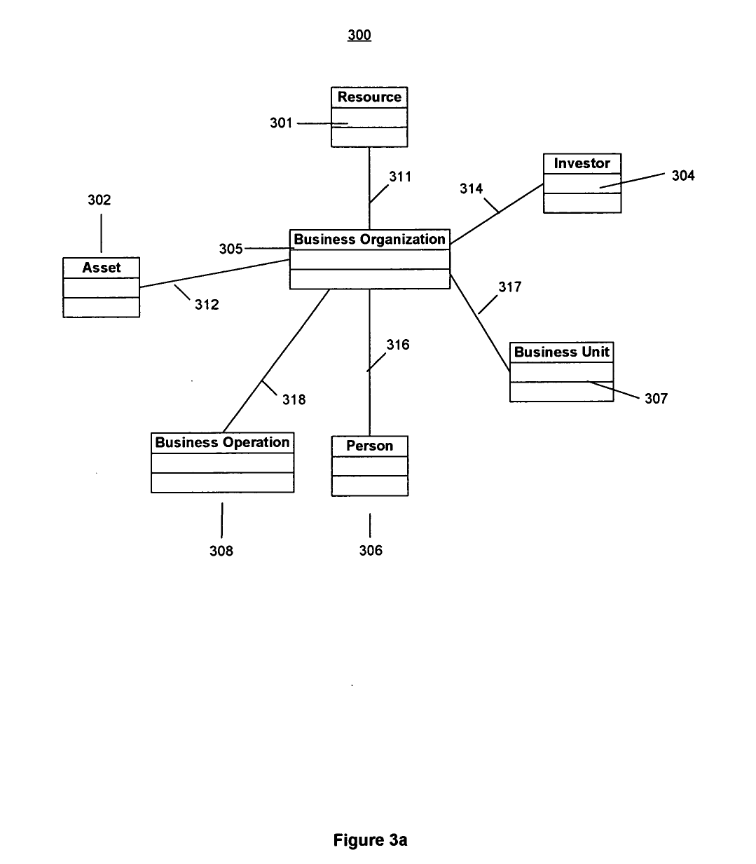

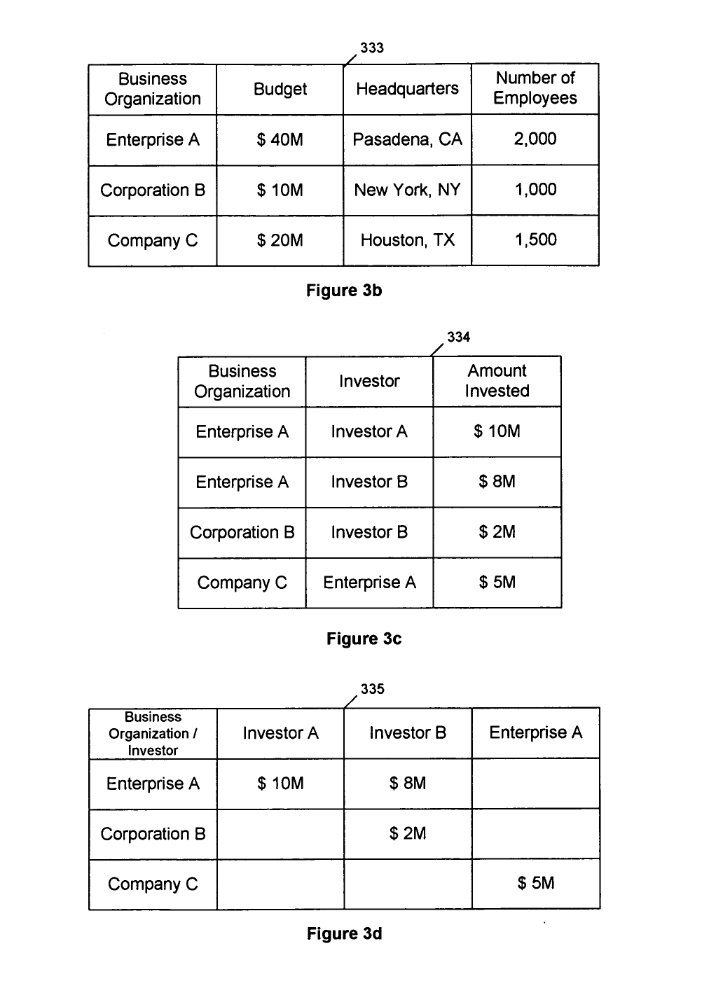

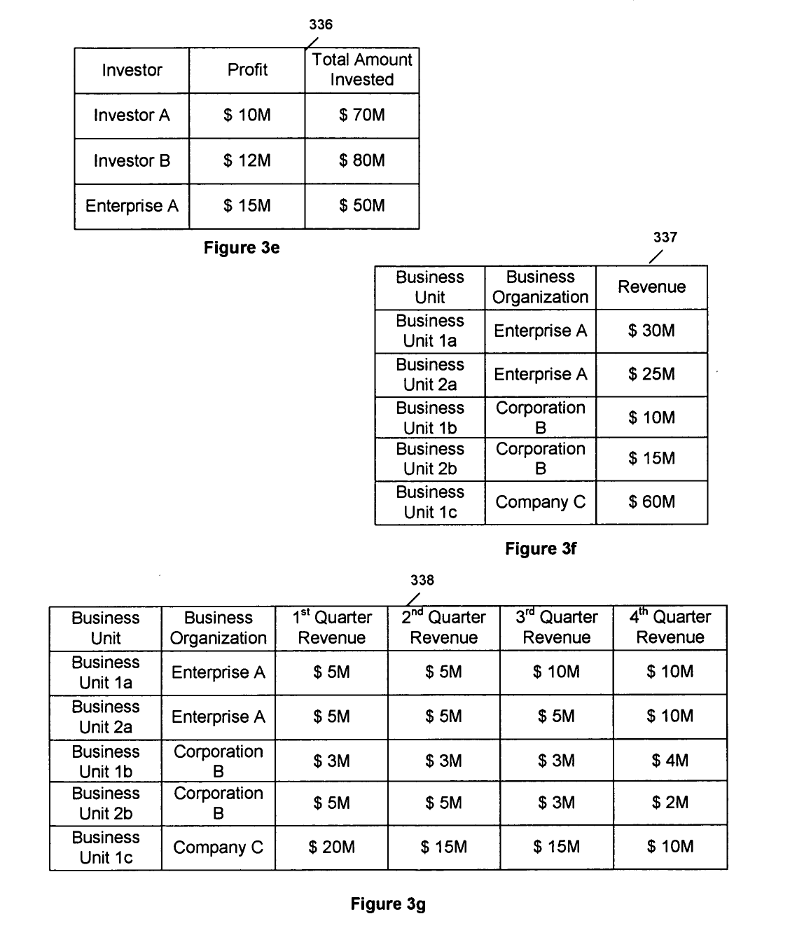

FIG. 3a is a block diagram 300 that shows relationships between an exemplary business organization entity 305; other exemplary entities that include an asset entity 302, a person entity 306, a business unit entity 307, and a business operation entity 308; and exemplary roles that include a resource role 301, and an investor role 304. The entities are represented by partitioned boxes and the roles are represented by ovals. Objects associated with the business organization entity 305 (“business organization objects 305”) may, for example, describe legal entities that play roles in a business environment. Such objects may represent small, medium, and large businesses, or government organizations.

For ease of explanation, an object will often be referred to by its associated entity. For example, a “business organization object 305” will be an object whose associated entity is a business organization entity 305.

An example of a database representation 333 of the business organization entity 305 is shown in FIG. 3b. The business organization entity 305 has attributes, such as “Budget,” “Headquarters,” and “Number of employees.” The business organization objects 305 are Enterprise A, Corporation B, and Company C. Each of these business organization objects is assigned values for attributes budget, headquarters, and number of employees.

The business organization entity 305 also includes built-in relationship types that describe relationships between objects associated with the business organization entity 305 and objects associated with other entities and roles. The built-in relationship types are represented in FIG. 3a as line segments linking business organization entity 305 to other entities and roles. Asset-ownership relationship 312, Resource-ownership relationship 311, business-interest relationship 314, division relationship 317, employee-affiliation relationship 316, and operation relationship 318 describe relationship objects that connect business organization objects 305 to asset objects 302, to resource objects 301, to investor objects 304, to business unit objects 307, to person objects 306, and to operation objects 308, respectively. Asset-ownership relationship 312, for example, represents ownership of an asset object 302 by a business organization object 305. Resource-ownership relationship 311, for example, describes which business organization objects 305 have access to which resource objects 301. Resource objects 301 may describe financial resources such as banks and venture capitalists. Business-interest relationship 314, for example, describes which objects of investor 304 have invested in which objects of business organization 305 and the amount of money invested. Division relationship 317, for example, describes which business unit objects 307 belong to which business organization objects 305. Examples of business unit objects 307 include departments, company divisions, and cost centers. Operation relationship 318, for example, describes which business operation objects 308 are performed by which business organization objects 305. Employee-affiliation relationship 316, for example, describes which person objects 306 are assigned to which business organization objects 305. Person objects 306 may include objects that describe employees, contractors, and consultants

FIG. 3c shows a side-by-side database representation 334 of a business-interest relationship 314. In this representation, the first two elements of the top row contain two related object types (i.e., business organization 305 and investor 304) and the subsequent elements of the top row contain the attributes defined for the business-interest relationship 314. In this example, there is one attribute, “Amount Invested,” defined for the business-interest relationship 314. The related business organization 305 and investor 304 objects are listed side by side in the first two columns under their respective object types. For example: Investor A invests in Enterprise A; Investor B invests in both Enterprise A and in Corporation B; and Enterprise A invests in Company C. In this example, Enterprise A is both a business organization object 305 and an investor object 304.

FIG. 3d shows how the side-by-side organization of data in FIG. 3c may be reorganized in a matrix configuration 335. In FIG. 3d, the first column of entries represents business organization objects 305 and the first row of entries represents investor objects 304. All other entries represent the relationship attribute, “Money Invested.” An entry holds a relationship attribute value for the objects that occupy the same row and column as the entry. For example, the entry occupying the third row and third column of the table holds an attribute value that corresponds to the amount of money invested into Corporation B by Investor B.

An exemplary database representation 336 of the investor role 304 is shown in FIG. 3e. Investor objects Investor A, Investor B, and Enterprise A are listed in the first column on the left, and values for attributes describing the objects are listed in the subsequent columns. When the Enterprise A object assumes the role of an investor, Enterprise A inherits all of the default attributes and relationships assigned to the investor role 304.

FIG. 3f shows an exemplary database representation 337 of the division relationship 317 that describes parent/child relationships between business unit objects 307 and business organization objects 305. For example, Business Units 1a and 2a are divisions of Enterprise A; Business Units 1b and 2b are divisions of Corporation B; and Business Units 1c and 2c are divisions of Company C. A relationship attribute, “Revenue,” is defined for the division relationship 317. The revenue attribute describes the revenue earned by each of the business units over a given time period.

Attribute values may be applied to a mathematical formula that generates a “rolled-up” attribute value. For example, the individual revenue attribute values for Business Units 1a and 2a may be “rolled up” or summed together to form a rolled-up revenue attribute value describing the total revenue earned by Enterprise A. A rolled-up attribute value may be computed in system memory 103 and stored in the object model 205.

The database representation of the division relationship 317 may be time stamped with a time value that represents, for example, a fiscal year. In this example, each of the revenue attributes would correspond to the same time period (e.g., the same fiscal year). In another example, shown in FIG. 3g, the revenue attributes may correspond to different time periods.

FIG. 3g shows an exemplary database representation 338 of the division relationship 317 in which the revenue attributes correspond to different time periods of a timeline. In this representation, the revenue attributes correspond to one of four quarters out of a fiscal year. The time values may, for example, be assigned automatically to the revenue attributes as revenue data is extracted from a data source 207. The time values may also be manually entered by a user.

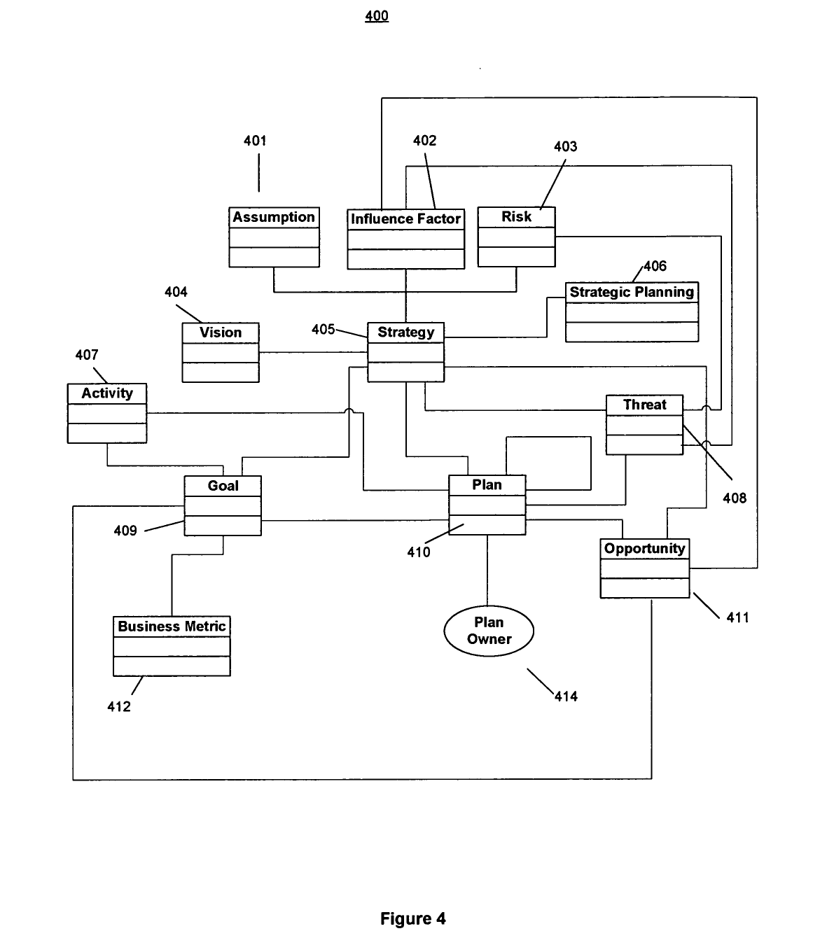

FIGS. 4-7 provide further examples of entities, roles, and relationships in context to a business environment model. As in FIG. 3a, entities are represented as partitioned boxes and roles are represented as ovals. A relationship is represented by a line connecting one object type to another object type.

FIG. 4 is a block diagram 400 that shows a strategy entity 405 and its relationships to other entities and roles. A strategy object 405 may be created by a strategic planning process object 406, and may help to achieve a vision object 404. A strategy object 405 may be influenced by assumption objects 401, influence factor objects 402, and risk objects 403. A strategy object 405 may be motivated by threat objects 408. A strategy object 405 may have an associated plan object 410 that may include an activity object 407. A plan object 410 may have an assigned plan owner object 414 that is represented as a role performed by a person object 306. A plan object 410 may be related to multiple sub-plan objects that are associated with plan entity 410. A strategy object 405 and associated plan objects 410 help to achieve one or more goal objects 409. Attributes of goal objects 409 may include time intervals or deadlines by which the goal objects 409 must be accomplished. Successful accomplishment of goal objects 409 may be measured by one or more business metric objects 412.

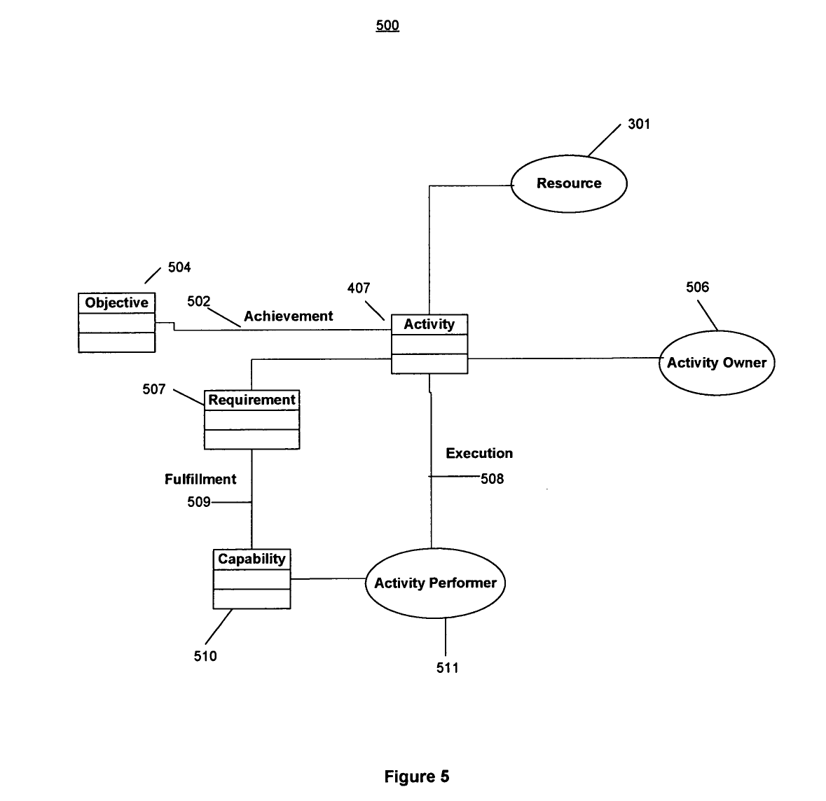

FIG. 5 is a block diagram 500 that shows an activity entity 407 whose associated objects contain information related to identifiable tasks that consume resources objects 503. A resource object 503 is represented as a role performed by a person object 306 or an asset object 302. An activity object 407 may have one or more related objective objects 504 to be accomplished within given time intervals. Attributes of objective objects 504 may include time intervals or deadlines by which the objective objects 504 must be accomplished. An activity object 407 may be assigned to a person object 306 having the role of activity owner 506. A person object 306 playing a resource role 503 may also assume an activity performer role 511. An activity performer object 511 may have capability objects 510 needed to service specific requirement objects 507 that are related to an activity object 407. An achievement relationship 502, a fulfillment relationship 509, and an execution relationship 508 describe relationship objects whose attributes contain status information measuring accomplishment. For example, an execution relationship object 508 may contain attributes that represent a status (e.g., “in-progress” or “complete”) of an activity object 407 assigned to an activity performer object 511. Such an attribute may, for example, be a numerical value on a graduated scale of values that represent progress.

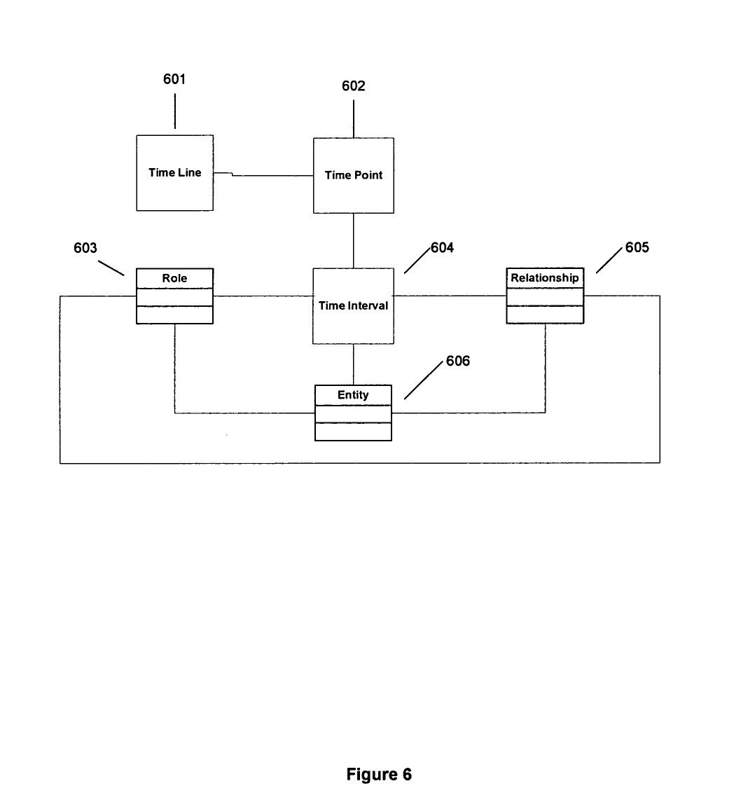

FIG. 6 shows timing relationships between role objects 603, entity objects 606, relationship objects 605. Relationship objects 605 may be associated with one or more role objects 603 for the duration of a specified time interval 604. Both role objects and relationship objects are related to entity objects 606. A time interval 604 may be composed of two time points 602 (beginning and end points) on a time line 601.

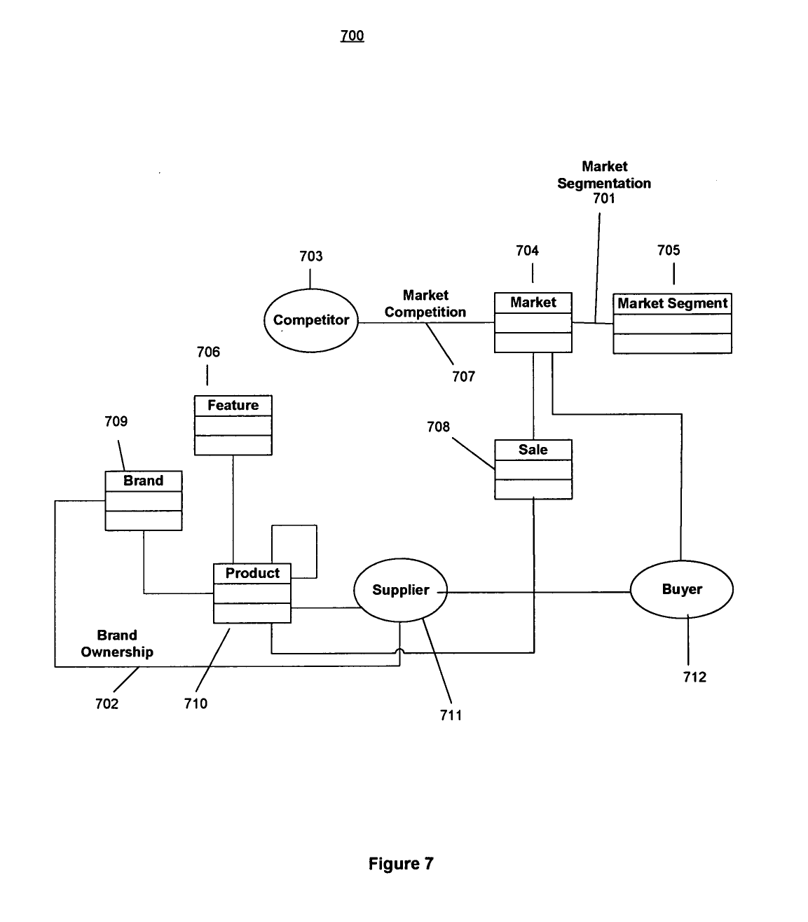

FIG. 7 shows a market entity 704 and its relationships to other entities and roles. A market object 704 may include a category of potential buyers that purchase a group or category of products. A buyer role 712 is performed by objects of an entity such as a person entity 306, a business organization entity 305, or a business unit entity 307 within a business organization. The product objects 710 may have similar characteristics or feature objects 706. A market object 704 may be segmented in any number of ways into market segment objects 705 that represent collections of potential buyer objects 712 with common characteristics. Boundaries of a market segment object 705 may be defined by a set of value ranges for common attributes of buyer objects 712. The attribute value ranges that define a market segment object 705 may be stored within a market segmentation relationship object 701. Market activity may be described by a volume of sales objects 708 of product objects 710 from a supplier object 711 to a buyer object 712. A market object 704 may be associated with a set of competitor objects 703. A competitor role 703 is performed by objects of an entity such as a business organization entity 305 that may also perform a supplier role 771. A competitor role object 703 may compete with other suppliers to sell products to buyers. The relationships between competitor objects 703 may be described by market competition relationship objects 707. Supplier objects 711 own brand objects 709 that uniquely label and position related product objects 710. Ownership of brand objects 709 by supplier objects 711 may be described by brand-ownership relationships 702.

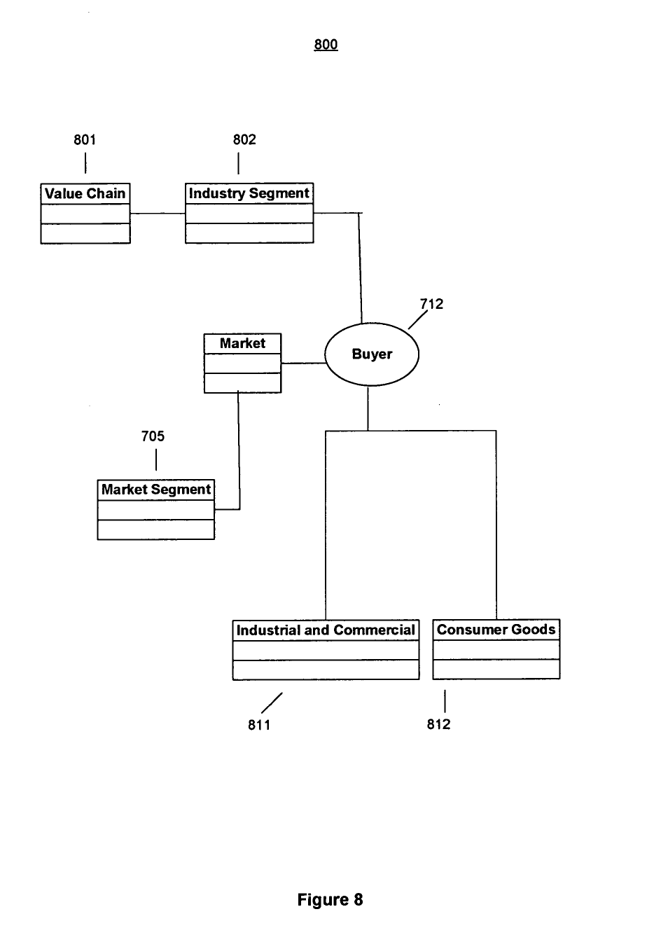

FIG. 8 depicts examples of relationships between entities and roles in a market segmentation model. A market segmentation model may identify differences in buyer needs and purchasing behavior and assist a company in developing marketing programs. A market object 704 may be composed of one or more market segment objects 705. A market segment object 705 may be mapped to groups of buyer objects 712. Buyer objects 712 many purchase industrial and commercial product objects 811 and/or consumer good objects 812. The grouping of buyer objects 712 may be governed by the selection of buyer attribute values. For example, buyer objects 712 may be grouped by buyer type, geographic location, product variety, and distribution channel. Industry segment objects 802 group buyer objects 712 according to segmentation variables. A value chain object 801 may be mapped to an industry segment object 802 to optimize the production and delivery of products while maximizing value and competitive advantage.

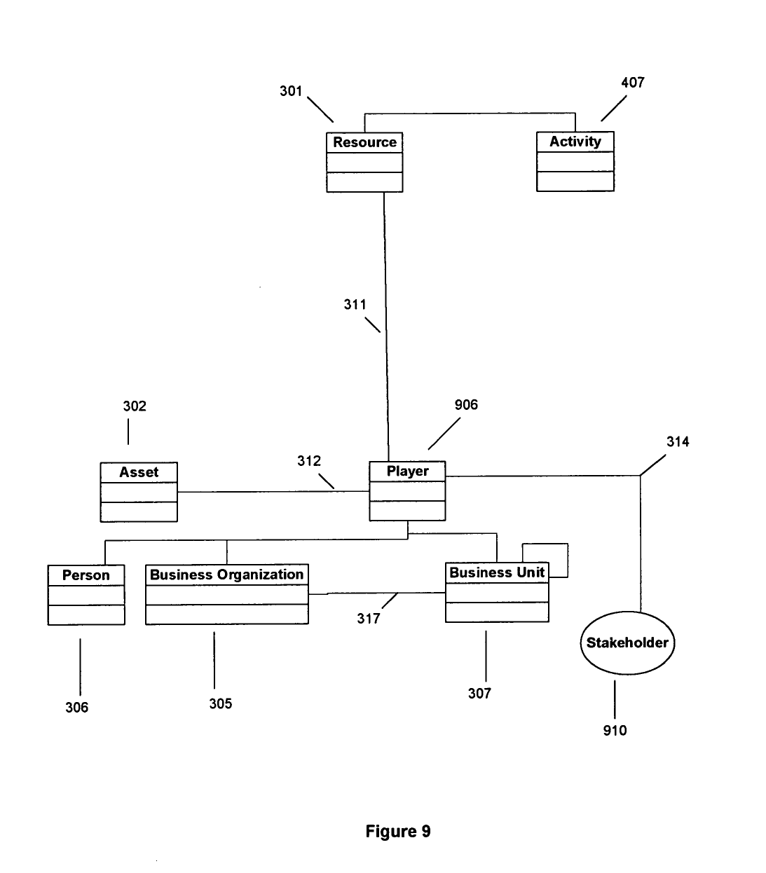

FIG. 9 provides a depiction of the deployment of resource objects 503 in support of activity objects 407. A resource role 503 may be performed by objects of entities such as an asset entity 302 or a player entity 906. An asset object 302 or a player object 906 may be owned by a person object 306, a business organization object 305, or business unit object 307. A player object 906 may be any legal entity, such as a company. A stakeholder object 910 may have a business interest in a player object 906.

A visual data model includes an underlying object model 205 and one or more model views. A model view is a visual representation of at least a portion of the objects and relationships contained in the underlying object model 205. A model view may comprise a set of nodes and lines arranged in a three-dimensional space. A node is a visual representation of one of the objects in the underlying data model. A line is used to represent a relationship between two objects in the underlying data object model. Each node and line defined in a model view has an associated set of visual properties and view properties. The visual properties contain data values that define visual characteristics of the objects such as color, shape, size, location, label color, font type, font color, level of transparency, and anchor positions for connections and labels. The view properties contain values associated with the layout and positioning of objects in the three-dimensional space. The view properties also contain rules that determine which objects are displayed in a model view.

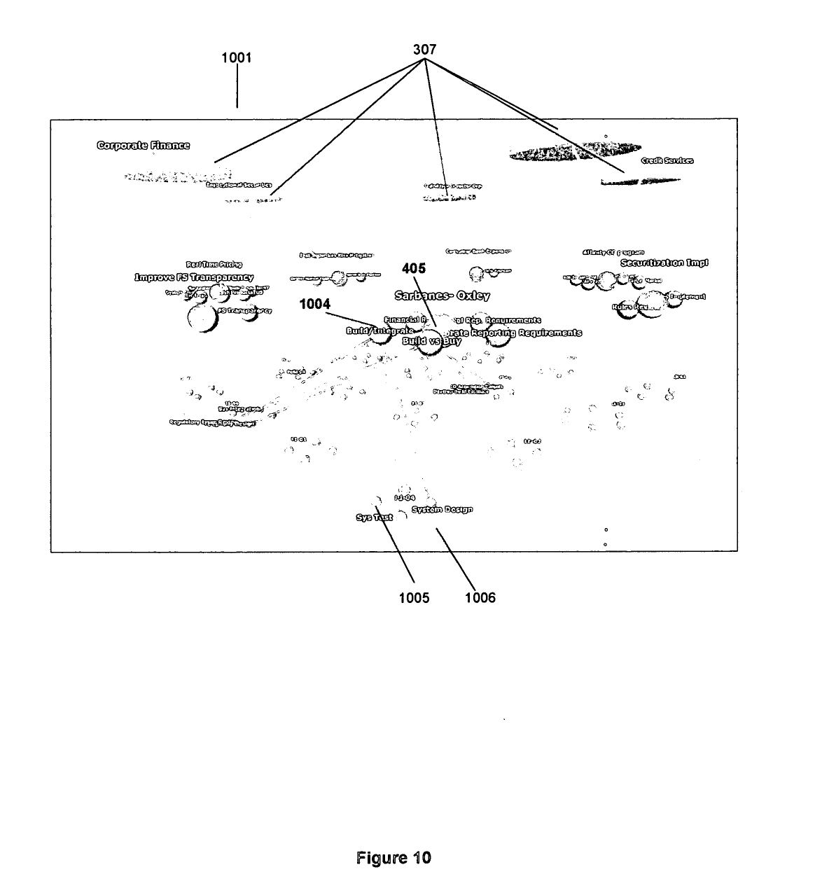

An example of a three-dimensional model view 1001 of a business environment model is shown in FIG. 10. In the model view 1001, objects are organized in planes within the three dimensional space. Business unit objects 307 are displayed in the top-most plane. Corporate strategies objects 405 and strategic initiative objects 1004 are displayed in the middle plane. Project objects 1005 and cost center objects 1006 are displayed in the bottom plane. The relationships between objects are depicted in different ways. For example, strategic initiative objects 1004 are oriented in a circle around a related strategy object 405. If a strategy object 405 is moved in the three-dimensional space, the related strategic initiative objects 1004 surrounding the strategy object 405 will move with the strategy object 405. In another example, a relationship between objects is represented by a configuration in which objects of one type are anchored to an object of another type. For example, project objects 1005 (shown as small spheres) are anchored to the surfaces of cost center objects 1006 (shown as square planes) that sponsor the project objects 1005. In a further example, line segments are used to depict the relationships between business unit objects 307 and the strategy objects 405. Line segments also depict the relationships between project objects 1005 and associated strategic initiative objects 1004.

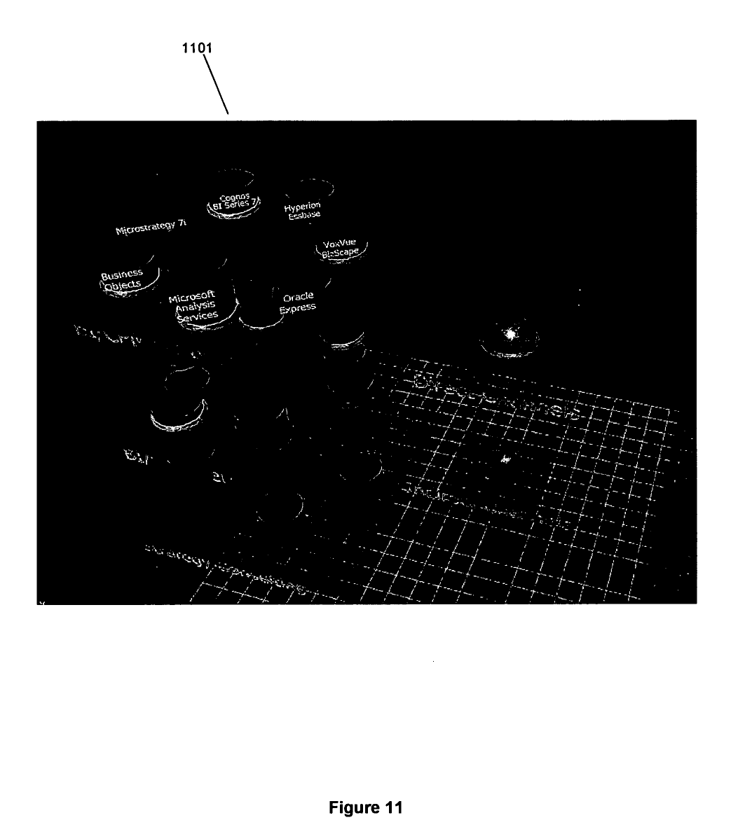

FIG. 11 depicts a three-dimensional model view 1101 in which colored rings represent a categorization value (such as the quality or reliability of the data) of an attribute associated with objects. In this example, the colors of rings wrapped around the objects are mapped to discrete values or ranges of values for a chosen attribute. The example also shows that objects of different types (i.e., objects with different visual representations) may have rings with colors mapped to the values of an attribute common to the different object types. Besides rings, other identifying marks such as stripes or dots may be used to visually display object attribute categorizations.

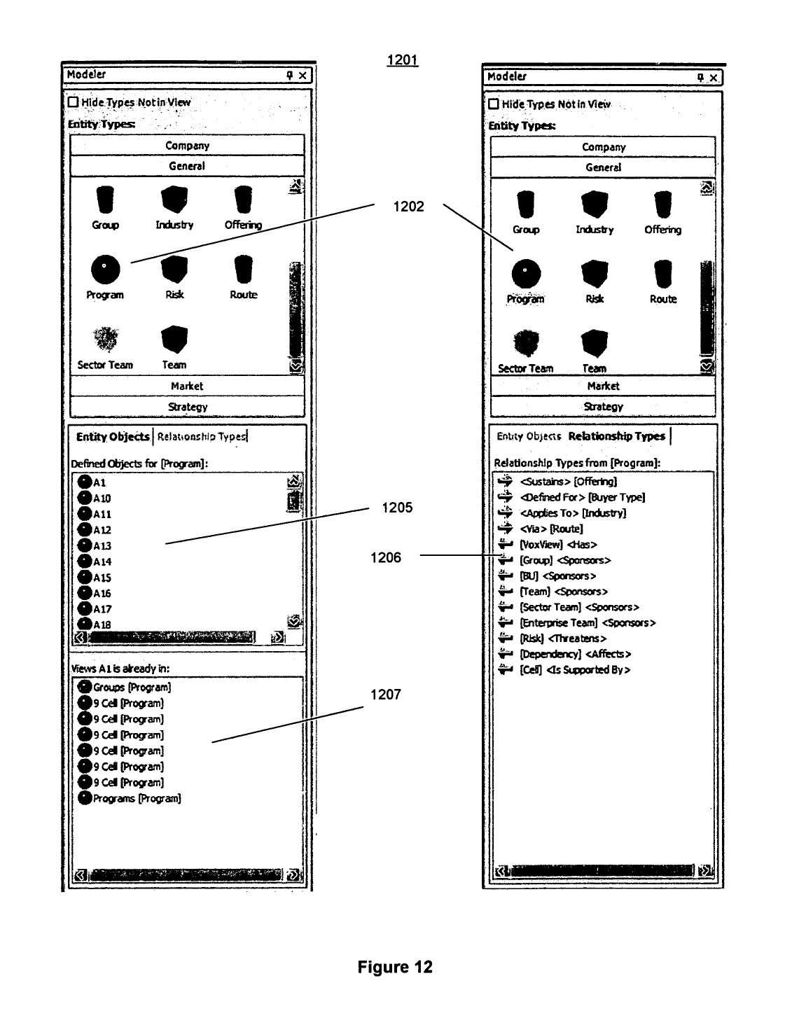

The objects of a visual data model may be initially built by importing data from data sources 207 which may include textual tables from a data file, SQL or OLAP databases, or a set of spreadsheets. Objects may also be manually configured or modified through the controls provided by a modeler pane 1201 as shown in FIG. 12. The modeler pane 1201 provides a default set of visual objects for entities and categorizes the entities in groups: company, general, market, and strategy. For example, a program entity 1202 within the “general” group of entities is represented as a black sphere. When an entity is selected in the modeler pane 1201, the names of all of the objects associated with the selected entity are listed. For example, selecting program entity 1202 program causes program objects (labeled “A1”, “A10”, etc) 1205 to be displayed. When an object (e.g., program object A1) is selected, model views 1207 containing the selected object are displayed in the modeler pane 1201. An entity object may be added to a model view by selecting the object and dragging the object into the model view.

After the entities of a model are defined, relationships between entities may be established. By selecting an object shape within the modeler pane 1201, a pick list 1206 of default relationships for that entity may be displayed. The pick list 1206 shows default relationships belonging to the selected entity, descriptions of the relationships including directions of relationships, and other entities and roles bound to the relationships. For example, the angle-bracketed text (e.g. “<Sustains>”) describes the nature of the relationship of the selected entity (i.e., program) to another entity or role in square brackets (e.g., “[Offering]”). An arrow icon represents the direction of the relationship. The first entry in the pick list 1206 describes a relationship between a program object and an offering object in which a program object sustains an offering object. For example, a program object could be a university department and an offering object could be a course taught by faculty members belonging to the university department. The first entry in the pick list 1206 may, for example, describe a relationship between a course and the university department offering the course.

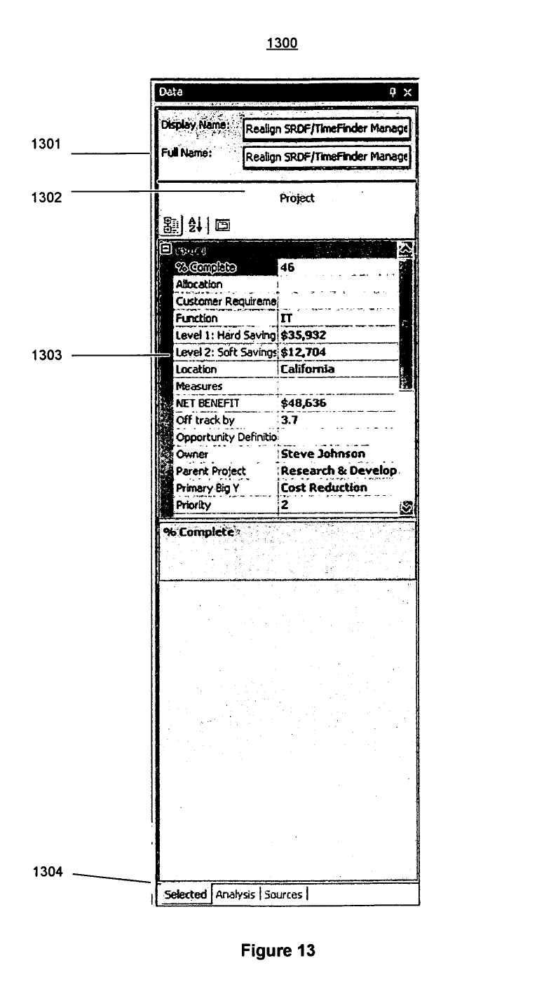

FIG. 13 shows a data control pane 1300 for displaying information associated with an object selected in a view. The data control pane 1300 displays the name of an object 1301, the entity to which the object is associated 1302, and a list of attributes whose names and values displayed in a table 1303. The table 1303 may include additional columns declaring for each attribute such information as the source of the data, the reliability or confidence level of the data, the access privilege level, last update information, etc. The data control pane 1300 may be used to group or access other data related manipulation, control, or analysis functions 1304.

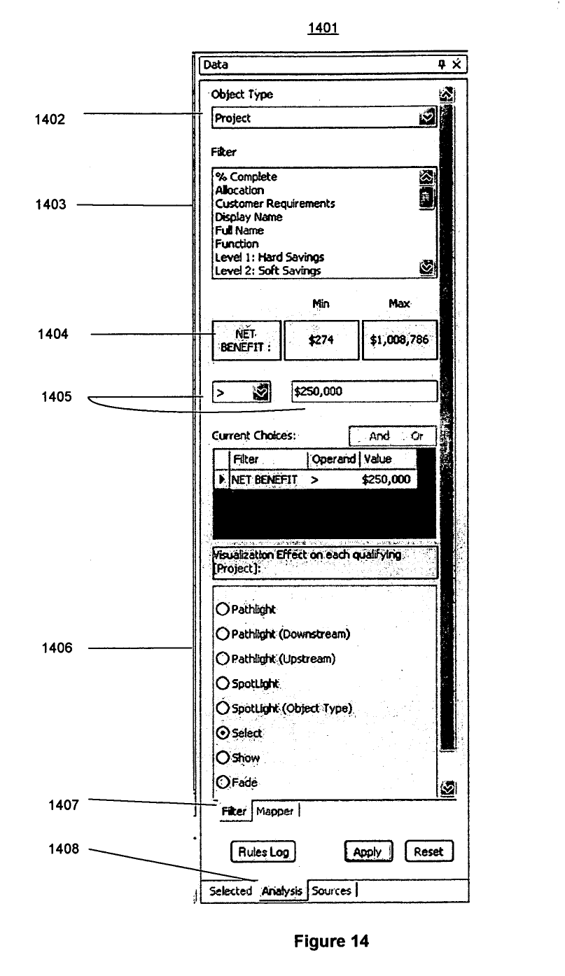

FIG. 14 presents an example of a data control pane 1401 that may be used to produce visual effects on a model view when an analysis function 1408 is selected. For this example, the visual effects are defined by a set of parameters that a user enters into the interface 1401. The parameters include an object type (i.e., an entity or role) 1402 and attributes 1403 belonging to the object type. The parameters, when applied to a filter operation 1407, specify which objects in a model view are to be hidden according to the parameters. A range of values for an object attribute 1404 within the model view may be displayed s an aid in specifying a filtering rule 1405. The data control pane 1401 may provide a list of filter operations 1406 that produce different visual effects on a model view.

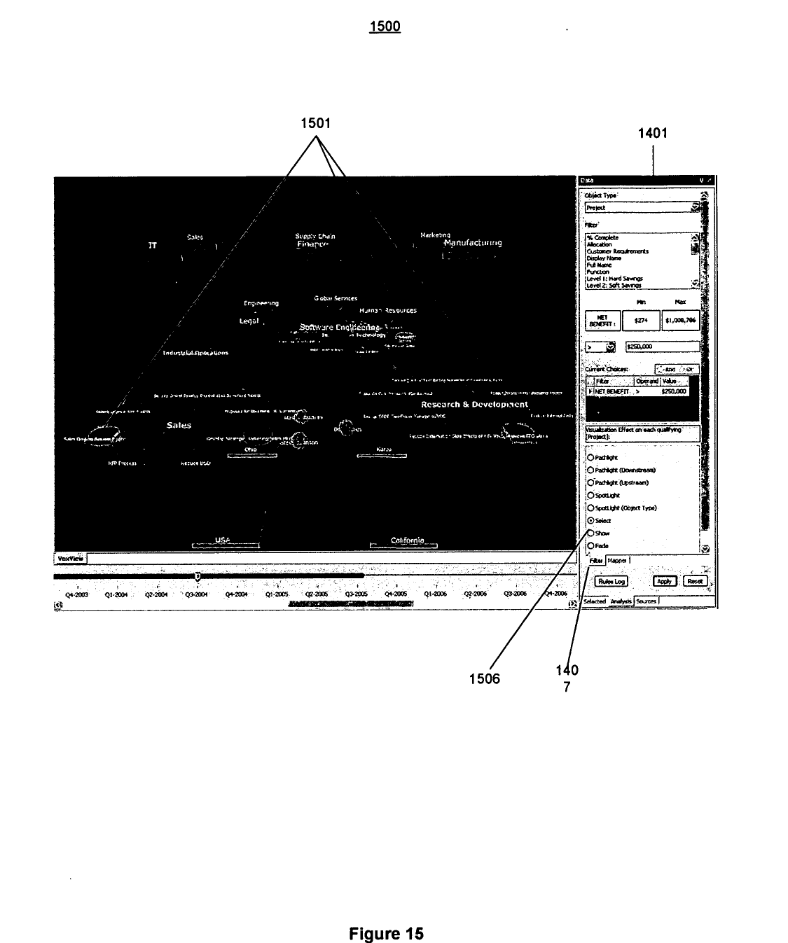

FIG. 15 shows a visual effect 1500 of a “select” filter operation 1506. The select operation 1506 selects the project objects 1501 whose “Net Benefit” attribute value 1404 that is greater than the $250,000 specified in the filtering rule 1405.

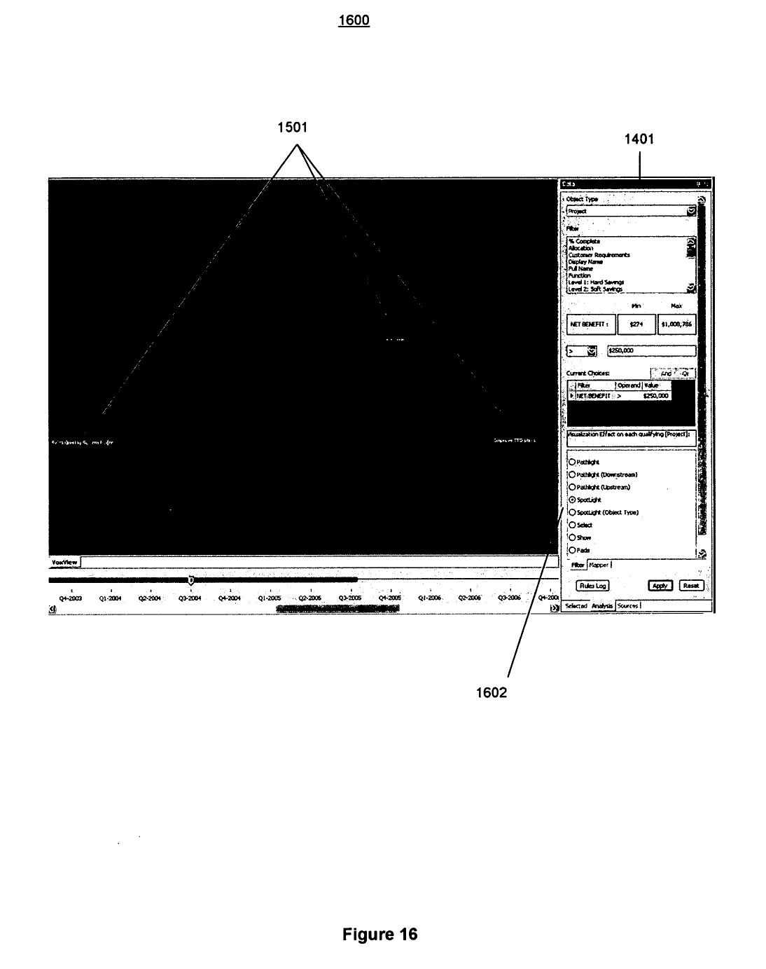

FIG. 16 shows a visual effect 1600 produced by a “spotlight” filter operation 1602. A spotlight operation 1602 causes all objects and relationships that do not meet the specified filter requirements to fade. The project objects 1501 are the only objects that meet the filtering rule 1405 and thus are the only objects that remain visible.

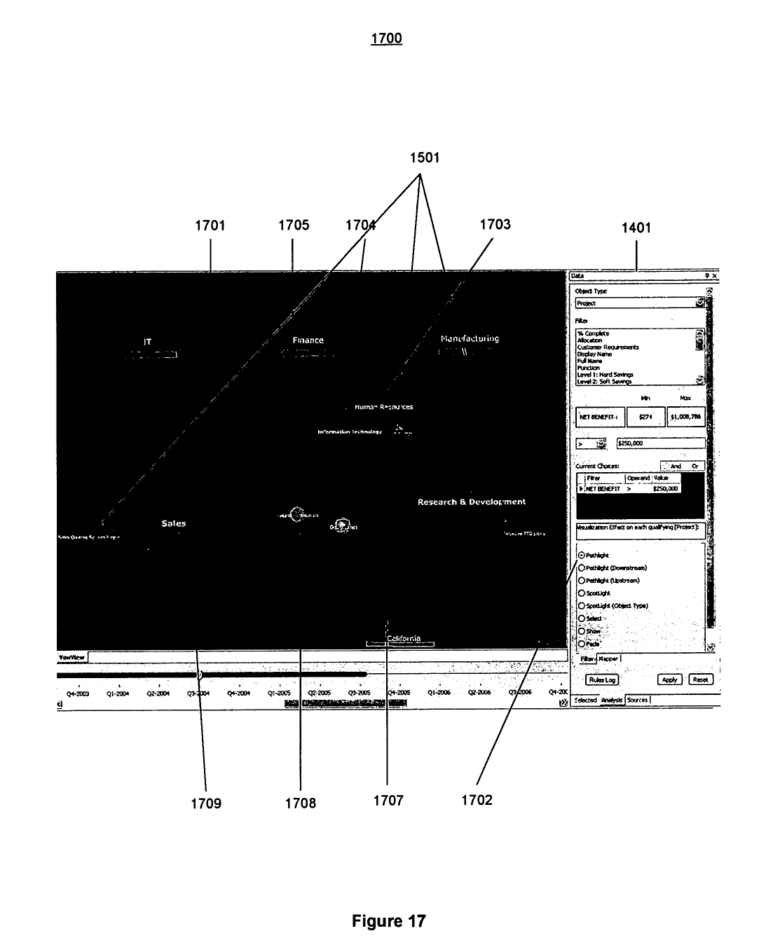

FIG. 17 shows a visual effect 1700 produced by a “pathlight” filter operation 1702. A pathlight operation 1702 displays objects meeting the filtering rule 1405 and their related objects. For the example shown, the project objects 1501 that meet the filtering rule 1405 are shown as before in FIGS. 15 and 16. In addition, the owner objects 1708, the parent project objects 1709, the organization objects 1703, the corporate function objects 1705, and the location objects 1707, which are all related to the project objects 1501, remain visible. All other objects and relationships are visibly faded in the model view 1701.

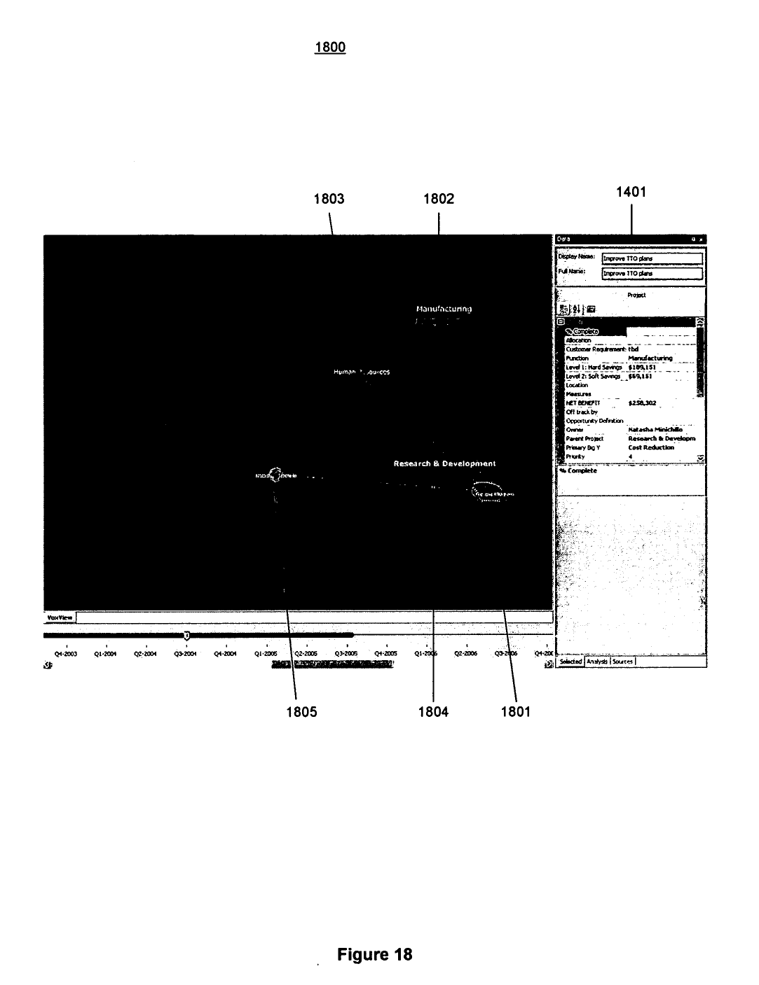

FIG. 18 shows a visual effect 1800 produced by a pathlight operation 1702 applied to a selected object 1801. A mouse control or icon button may be provided to invoke a pathlight operation 1702 on a selected object 1801. Selecting the project object 1801 named “Improve TTO plans” within the original view as depicted in FIG. 15 displays the selected object 1801 and all other objects related to the selected object 1801. In the example, one may easily determine the owner objects 1801, the parent project objects 1804, the function objects 1802, the human resources objects 1803 and the sponsoring organization objects 1805 that are associated with the selected project object 1801.

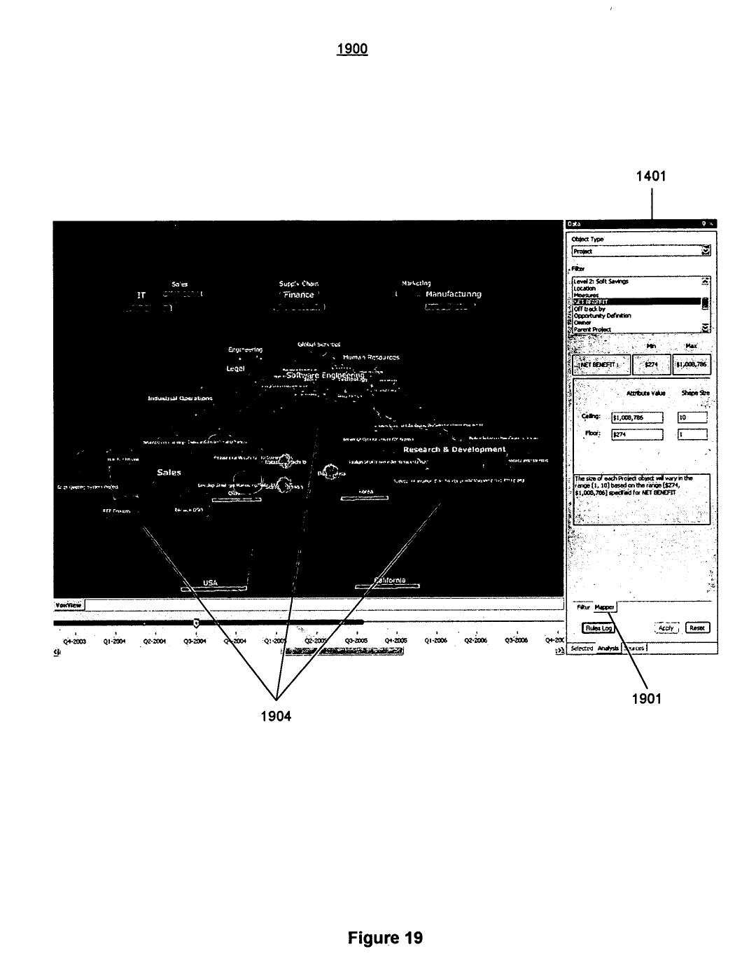

FIG. 19 shows a visual effect 1900 produced by mapping visual properties of one or more objects to variables bound to attribute values. A mapping operation 1901 is selected at the bottom of the data control pane. Examples of visual properties include height, width, volume, and color. In the example shown in FIG. 19, the heights of the blue cylindrical shapes 1904 representing project objects are mapped to a value range of the “Net Benefit” attribute. A height of ten units corresponds to a maximum net benefit attribute value of $1,008,786, while a height of one unit corresponds to a minimum net benefit attribute value of $274. The units of dimension are arbitrary and may be adjusted manually by the user or set to a default value.

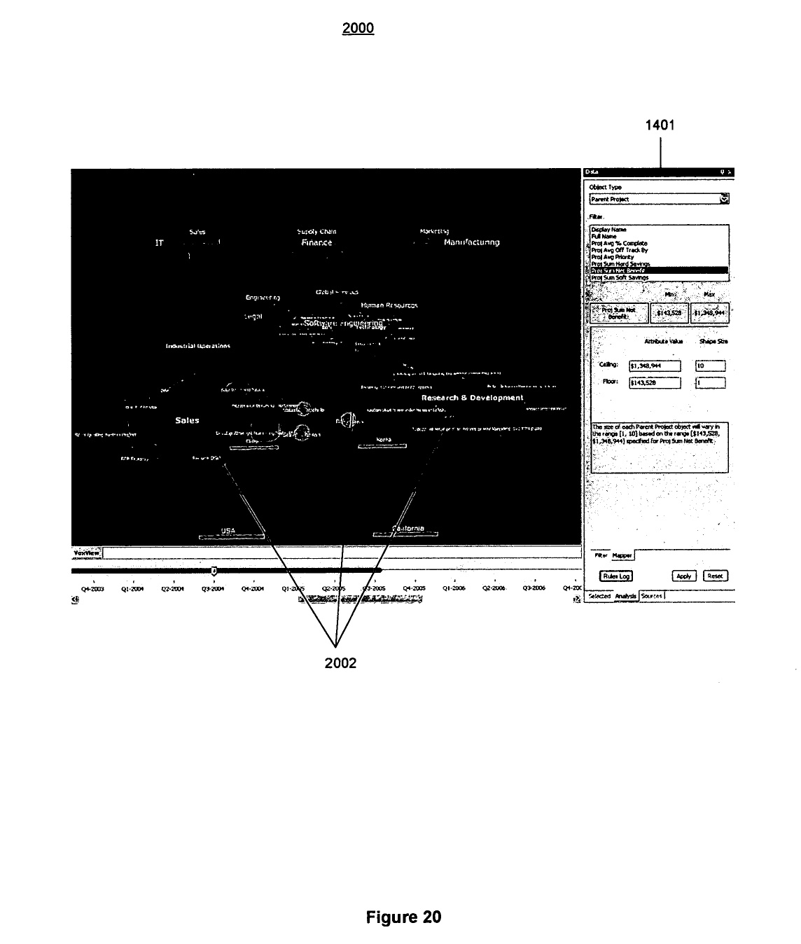

FIG. 20 shows a visual effect 2000 produced by a combination of select, spotlight, pathlight, and mapping operations 1506, 1602, 1702, and 1901. The heights of the red cylindrical shapes 2002 representing parent project objects are mapped to the value range of a “Proj Sum Net Benefit” attribute. Visual effects of operations may be added and deleted from the model view. Furthermore, the model view may be reset or restored to a “baseline” view. The baseline view may be set at any time to equal a current view.

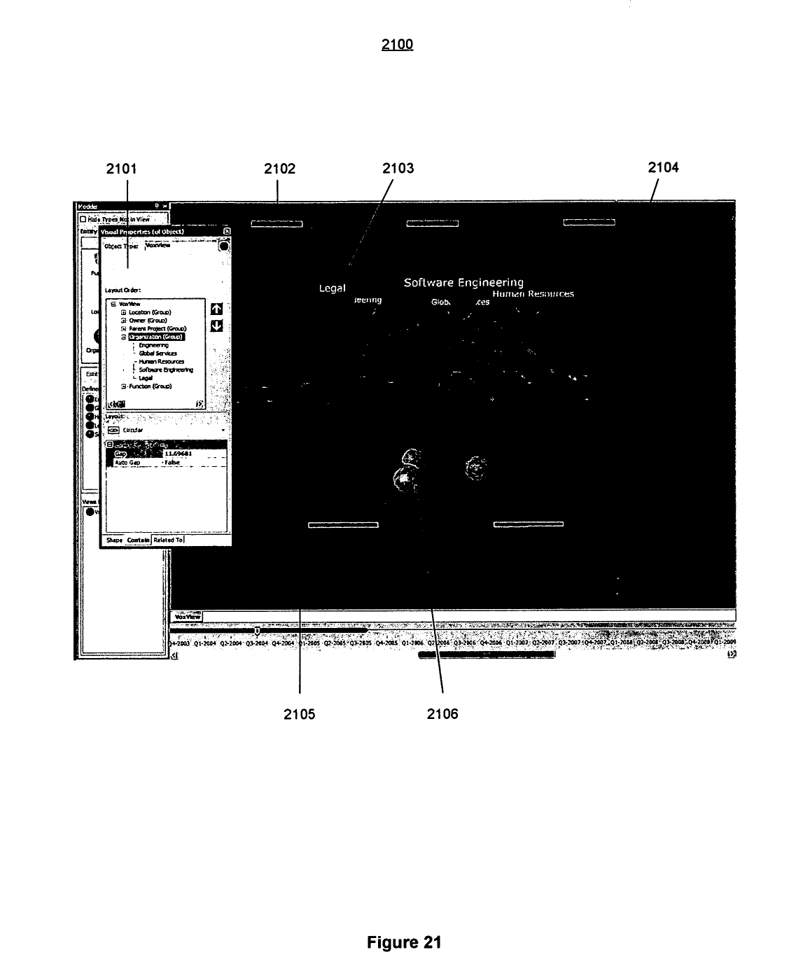

FIG. 21 shows an example of a view layout 2100 of the model view shown in FIG. 20. Each object within the view is attached to one of five parallel planes 2102, 2103, 2104, 2105, and 2106. A visual properties interface 2101 allows a user to view and adjust the visual properties of objects. For example, the planes may be rotated about the x-, y-, and z-axes of the three-dimensional space to present different perspectives of the model view. The spacing between planes and the spacing between objects within a plane may also be adjusted by a user.

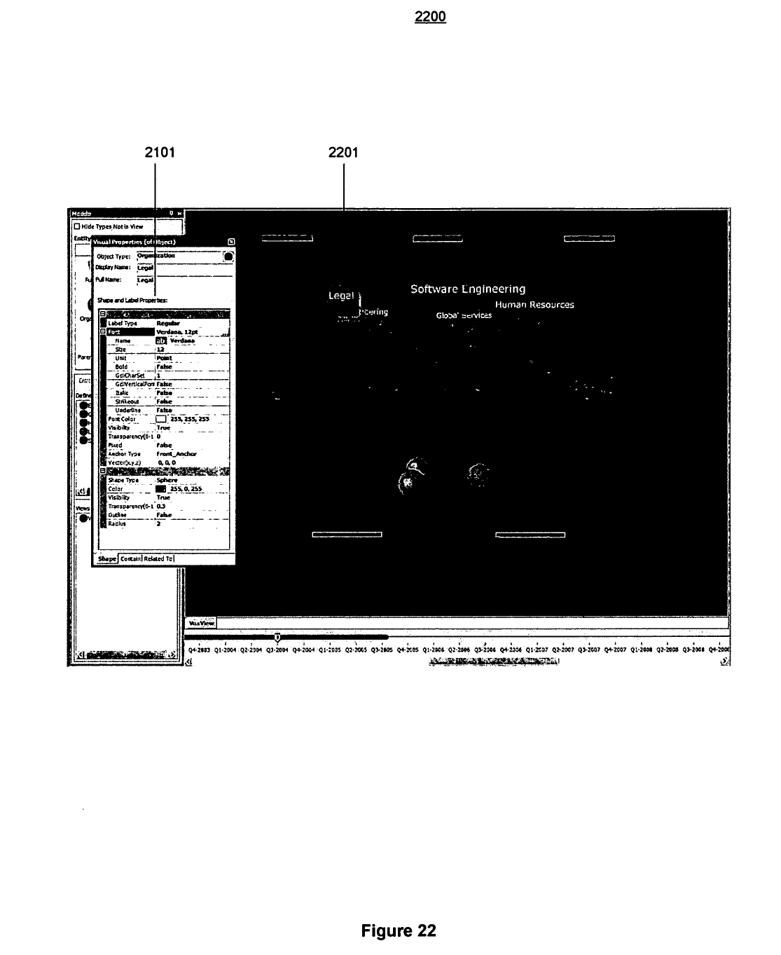

FIG. 22 shows an example 2200 of using the visual properties interface 2101 to adjust visual properties of a selected object 2201. A selected object 2201 is displayed inside a highlighted box. The visual properties of the selected object 2201 include shape and label properties. Examples of label properties include text font, font color, transparency, and a position of the label with respect to the object. Examples of shape properties include a shape type (e.g., a cube or a sphere), a color, visibility, transparency, an outline thickness, and shape dimensions.

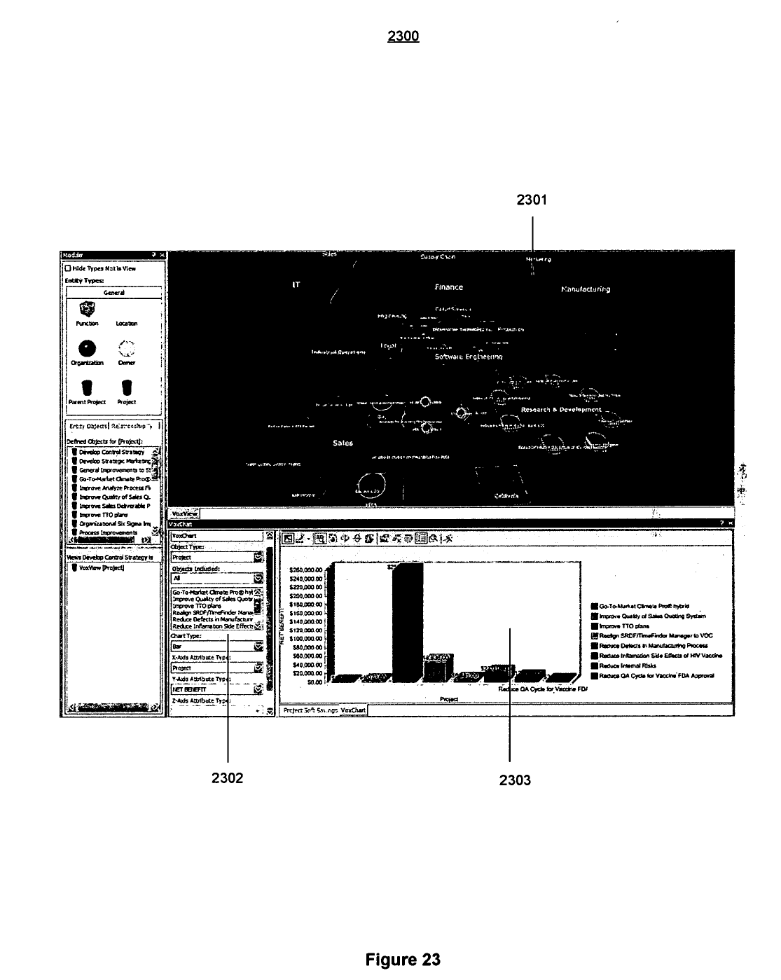

FIG. 23 shows an example 2300 of graphical charting with model object selection. A chart 2303 displays an attribute value for selected objects 2301 in a model view. The properties of the chart 2303 may be selected and adjusted using an interface 2302.

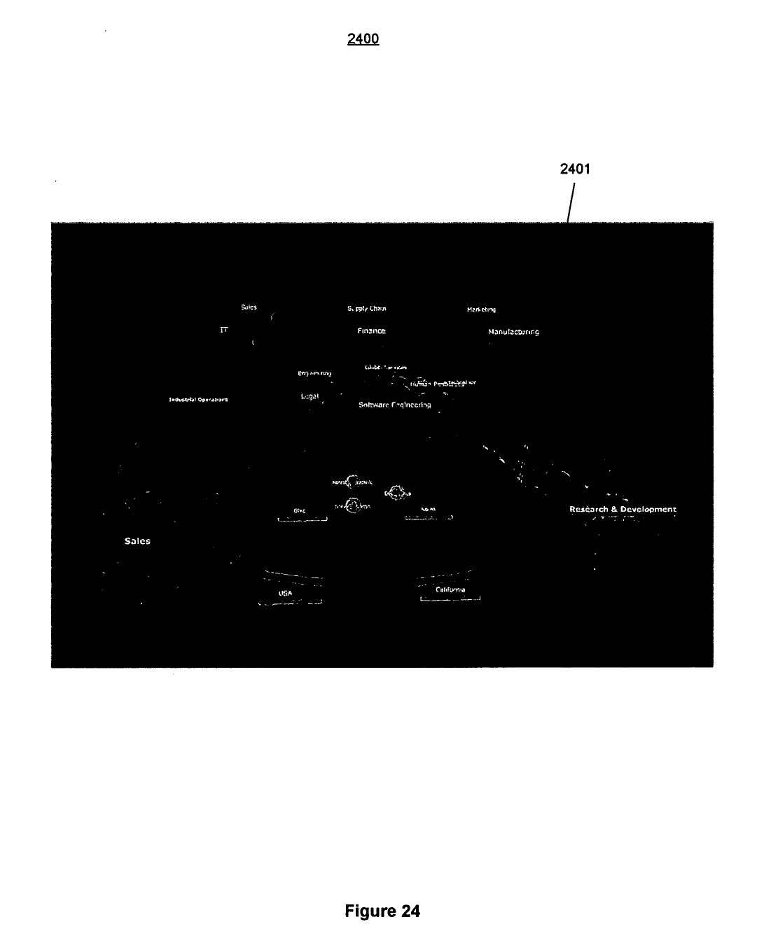

FIG. 24 shows a model view 2400 in which a layout control tool 2401 is used to adjust the spacing between objects. The layout control tool 2401 includes a circle that intersects groupings of objects. Adjusting the radius of the circle adjusts the spacing between the groups of objects intersected by the circle. A user may adjust the circle by clicking on the circle and dragging the circle such that the circle contracts or expands based on the movement of the mouse. The user may also adjust the radius of the circle by entering a value for the radius.

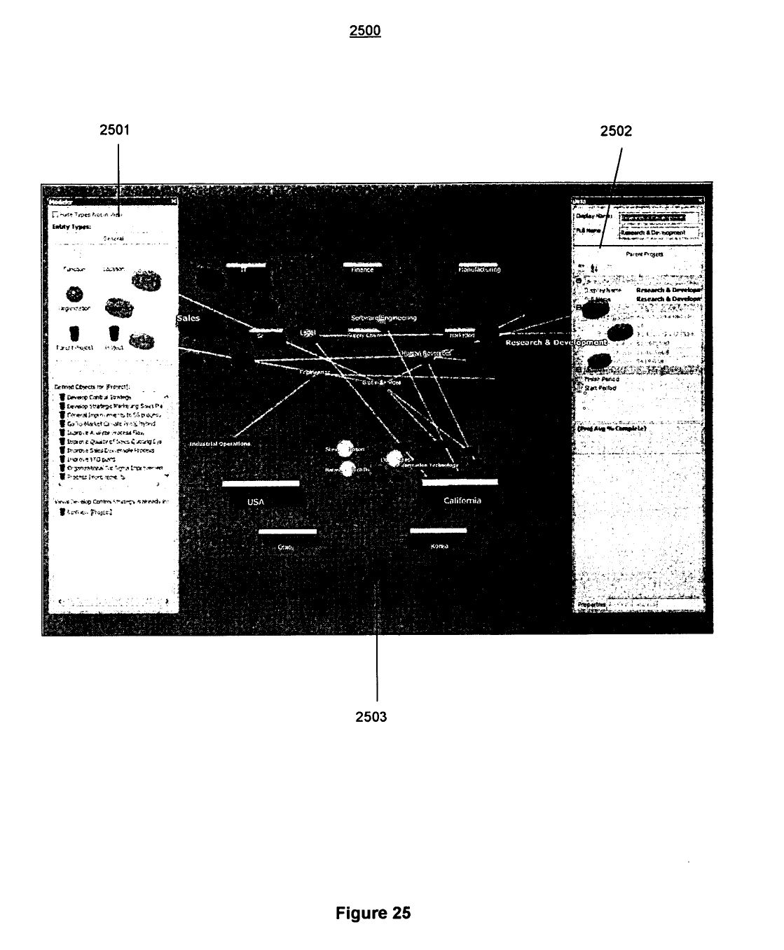

FIG. 25 shows the objects of the model view of FIG. 15 from a bottom view perspective. The transparency of the modeler pane 2501 and the data pane 2502 may be adjusted to a value that ranges between opaque and invisible. For example, if the modeler pane 2501 and/or the data pane 2502 overlap data objects in a model view, the transparency of the modeler pane 2501 and/or the data pane 2502 may be adjusted such that both the modeler pane 2501 and/or the data pane 2502 and the overlapping objects may be viewed simultaneously.

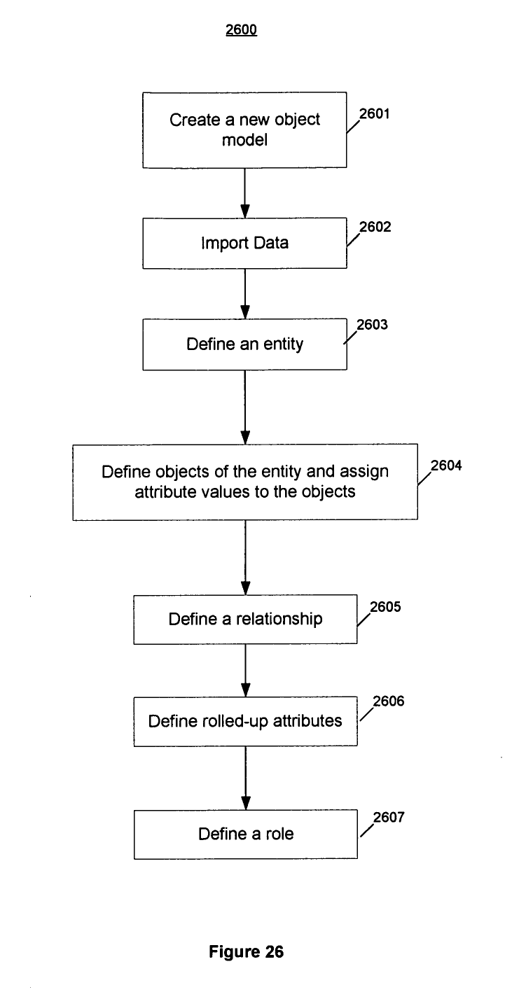

FIG. 26 illustrates a process 2600 for producing new objects in an object model 205 using the model builder 201a shown in FIG. 2. To begin process 2600, a user creates a new object model or opens an existing object model (2601). A user imports data from a file (2602) and defines an entity that characterizes the data (2603). The entity may also include default attributes. Furthermore, attribute values may be time stamped to indicate a time or time-period for which the attribute is valid. For example, a user may highlight cells in a spreadsheet and then specify that the first row of highlighted entries contains the identifiers of an entity and attributes related to the entity. A user defines objects of the entity and assigns attribute values to the objects (2604). For example, the column of entries listed directly below an entity identifier may contain objects associated with the entity and the columns listed below attribute identifiers may contain values for the attributes. Attribute values that are located in the same row as an object may correspond to that object. The user may specify the rows, columns, and entries of a data source that correspond to object types, attributes, objects, and attribute values. In this manner, data from different organizational arrangements may be entered into the model builder 201a.

A user imports data from a file (2602) and defines a relationship (2605) between objects of various entities. A relationship may also include default attributes. A user may, for example, highlight cells in the spreadsheet that include related objects and corresponding relationship attributes. Relationship attribute values may be time stamped. A user may define (2606) additional attributes, referred to as “rolled-up attributes” that depend on default attributes. A rolled-up attribute may, for example, be a mathematical function (e.g. a sum or product) of one or more default attributes. In one exemplary implementation, a user creates a rolled-up attribute from default attributes of a relationship between two entity objects and then assigns the rolled-up attribute to one of the entity objects. In another exemplary implementation, a rolled-up attribute depends on default attributes belonging to the same entity object to which the rolled-up attribute is assigned. In a further exemplary implementation, a rolled-up attribute depends on default attributes belonging to one or more entity objects that are different from the entity object to which the rolled-up attribute is assigned.

A user may define a role (2607) that characterizes roles that objects of one or more entities may perform. For example, business organization objects 305 may perform the roles of both a buyer and a seller. A role is defined (2607) in much the same way as an entity is defined; however, the objects of a given role are also associated with an entity.

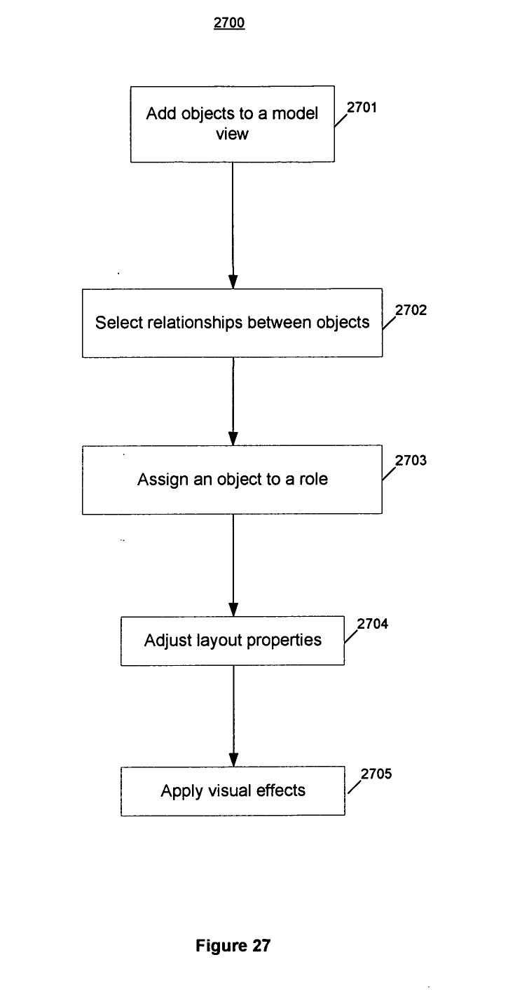

FIG. 27 shows a process 2700 by which the view builder 201b generates a model view of an object model 205 produced by the process 2600 in FIG. 26. A user may add objects to a model view (2701) by selecting the objects in the modeler pane 1201 and by dragging the objects into the model view. A user may adjust the visual properties of an object in the model view using the visual properties pane 2101 described in FIG. 21. Examples of visual properties include color, dimensions, labeling, and shapes of an icon that represents the object. A user may also select the relationships to be displayed between objects in the model view (2702) and specify how those relationships are visually represented. For example, line segments may be used to represent a relationship between two objects. In another example, the anchoring of objects to another object may represent a relationship. In a further example, a relative orientation between objects may represent a relationship.

A user may assign an entity object to a role (2703) by selecting the object and then selecting a role to which the object is assigned. Once a role is specified for an object, the object will assume all of the attributes and relationships assigned to the role. For example, if objects associated with the same entity are assigned to different roles, those objects will have different attributes and default relationships. After objects have been added to the model view, a user may adjust the layout properties of objects (2704). Examples of layout properties include the spacing between objects in a group, the spacing between groups of objects in a plane, and the spacing between groups of objects in different planes. Examples of layout properties also include the angle by which planes of objects are rotated in the three-dimensional space. For example, the planes may be rotated to show the model from a top-view perspective, a bottom-view perspective, a side-view perspective, or any other perspective within the three-dimensional space.

Visual effects may be applied (2705) to the model view to help a user perform further analysis of the model. Examples of visual effects include select, spotlight, pathlight, and mapping operations 1506, 1602, 1702, and 1901. A user may also view sequentially time-stamped model views of the same data model to see how the data model changes over time. For example, a user may move a slider to a date on a timeline to display the model view of the model that is time-stamped with the date.

The invention can be implemented in digital electronic circuitry, in computer hardware, firmware, software, or in combinations thereof The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating an output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for-executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A number of embodiments of the invention have been described. Nevertheless, it will be understood that various modifications may be made without departing from the spirit and scope of the invention. For example, the procedures in processes 2600 and 2700 may be performed in a different order and repeated multiple times. Furthermore, visual data models generated using the methods and systems described above are not limited to business models and may include, for example, military models, scientific models, and engineering models. Accordingly, other embodiments are within the scope of the following claims.

What is claimed is:

1. A computer-implemented method for generating a visual data model, the method comprising:
providing first and second objects that represent first and second portions of data from a model;
assigning attributes to the first and second objects, the attributes representing characteristics of the first and second portions of the data;
providing a relationship object that represents a relationship between the first and second objects; and
assigning, to the relationship object, a relationship attribute representing a characteristic of the relationship between the first and second objects.

2. The method of claim 1, further comprising:
mapping a visual property of a first visual object representing the first object to a characteristic of the data;
mapping a visual property of a second visual object representing the second object to a characteristic of the data;
mapping a visual property of a connector object representing the relationship object to a characteristic of the data; and
displaying the first and second visual objects and the connector object in a three-dimensional view space rendered on a two-dimensional surface.

3. The method of claim 1, wherein the first object is associated with an entity and the second object is associated with a role.

4. The method of claim 1, further comprising importing the data from a source that includes at least one of: an online transaction processing (OLTP) database, an online analytical processing (OLAP) database, a spreadsheet, an extensible markup language (XML) file, a hypertext-markup language (HTML) page, a text file, and a screen input.

5. The method of claim 1, further comprising defining a rolled-up attribute that depends at least in part on an attribute.

6. The method of claim 1, further comprising defining a rolled-up attribute that depends at least in part on a relationship attribute.

7. The method of claim 1, further comprising time stamping the attributes and the relationship attribute.

8. The method of claim 4, wherein importing the data further comprises receiving the data over a communications network.

9. The method of claim 2, further comprising connecting the first and second visual objects to the connector object.

10. The method of claim 2, wherein the visual properties of the first and second visual objects include at least one or more of: a shape, a color, a dimension, a transparency level, and a label.

11. The method of claim 2, further comprising anchoring the first and second visual objects to respective first and second parallel planes within the three-dimensional view space.

12. The method of claim 11, further comprising rotating the parallel planes about an axis such that the visual objects rotate with the parallel planes.

13. The method of claim 2, further comprising suppressing display of a subset of the visual objects.

14. The method of claim 13, wherein suppressing display comprises applying at least one of: a select filter, a pathlight filter, and a spot light filter.

15. A system for generating a visual representation of a model, the system comprising:
a model builder configured to produce objects of entities, roles, and relationships from data associated with the model; and
a view builder configured to create visual representations for the objects and to arrange the visual representations in a three-dimensional view.

16. The system of claim 15, further comprising:
a data import module for importing the data from a source; and a
data output module for storing the data in an output file.

17. The system of claim 16, wherein the source includes at least one of: an online transaction processing (OLTP) database, an online analytical processing (OLAP) database, a spreadsheet, an extensible markup language (XML) file, a hypertext-markup language (HTML) page, a text file, and a screen input.

18. The system of claim 16, wherein the output file includes at least one of: a chart, a graph, an extensible markup language (XML) file, and a database.

19. The system of claim 16, further comprising a network configured to:
transmit data to the data import module from a server connected to the network; and
transmit data from the data output module to a server connected to the network.

20. A computer-readable medium having instructions stored thereon that when executed by a computer cause the computer to:
provide first and second objects that represent first and second portions of data from a model;
assign attributes to the first and second objects, the attributes representing characteristics of the first and second portions of the data;
provide a relationship object that represents a relationship between the first and second objects; and
assign, to the relationship object, a relationship attribute representing a characteristic of the relationship between the first and second objects.

21. The computer-readable medium of claim 20, having further instructions that cause the computer to:
map a visual property of a first visual object representing the first object to a characteristic of the data;
map a visual property of a second visual object representing the second object to a characteristic of the data;
map a visual property of a connector object representing the relationship object to a characteristic of the data; and
display the first and second visual objects and the connector object in a three-dimensional view space rendered on a two-dimensional surface.

22. The computer-readable medium of claim 20, having further instructions that cause the computer to import the data from a source including at least one of: an online transaction processing (OLTP) database, an online analytical processing (OLAP) database, a spreadsheet, an extensible markup language (XML) file, a hypertext-markup ill language (HTML) page, a text file, and a screen input.

23. The computer-readable medium of claim 20, having further instructions that cause the computer to define a rolled-up attribute that depends at least in part on an attribute.

24. The computer-readable medium of claim 21, having further instructions that cause the computer to connect the first and second visual objects to the connector object.

25. The computer-readable medium of claim 21, having further instructions that cause the computer to anchor the first and second visual objects to respective first and second parallel planes within the three-dimensional view space.

26. The computer-readable medium of claim 21 having further instructions that cause the computer to rotate the parallel planes about an axis such that the visual objects anchored to the parallel planes rotate with the parallel planes.

27. The computer-readable medium of claim 21 having further instructions that cause the computer to suppress display of a subset of the visual objects.
